(19) United States
(12) Patent Application Publication
(10) Pub. No.: US 2021/0040363 A1
(43) Pub. Date: Feb. 11, 2021

(54) Moisture-curable Polyurethane Hot-melt Resin Composition and Article Obtained Using Same

(71) Applicant: DIC Corporation, Tokyo (JP)

(72) Inventors: Yukie Saitou, Takaishi-shi (JP); Toyokuni Fujiwara, Takaishi-shi (JP); Atsushi Ninomiya, Takaishi-shi (JP)

(21) Appl. No.: 16/954,683

(22) PCT Filed: Nov. 22, 2018
(86) PCT No.: PCT/JP2018/043137

§ 371 Date: Aug. 26, 2020

(30) Foreign Application Priority Data
Dec. 20, 2017 (JP) 2017-243867

(51) Int. Cl. C09J 175/06; C09J 11/06; C09J 5/06; C08G 18/48; C08G 18/42; C08G 18/20; C08G 18/12; C08K 5/42

(52) U.S. Cl. CPC C09J 175/06; C09J 11/06; C09J 5/06; C08G 18/48; C08G 2170/20; C08G 18/2081; C08G 18/12; C08K 5/42; C08G 18/4202

(57) ABSTRACT

The present invention provides a moisture-curable polyurethane hot-melt resin composition containing an isocyanate group-containing urethane prepolymer (i), where the moisture-curable polyurethane hot-melt resin composition further contains a curing catalyst (ii) represented by General Formula (1) below in an amount in a range of 0.2 to 1 parts by mass with respect to 100 parts by mass of the urethane prepolymer (i) and an organic acid (iii) having a sulfur atom in an amount in a range of 0.0001 to 0.5 parts by mass with respect to 100 parts by mass of the urethane prepolymer (i). The present invention also provides an article including at least two members bonded using the moisture-curable polyurethane hot-melt resin composition.

### TECHNICAL FIELD

The present invention relates to a moisture-curable polyurethane hot-melt resin composition and an article.

### BACKGROUND ART

To date, various studies have been conducted on the use of moisture-curable polyurethane hot-melt adhesives, which are solvent free, as environment-responsive adhesives mainly in the bonding of fibers and the lamination of building materials, and such moisture-curable polyurethane hot-melt adhesives have been widely used in industry.

In recent years, with the growing need for lighter and thinner optical components, research has been directed at replacing acrylic adhesives, which have been in the mainstream thus far, with hot-melt adhesives, in the bonding of optical components.

As an example of such an adhesive, an adhesive is disclosed that contains a moisture- and heat-resistant hot-melt adhesive composition having, with respect to (a) 100 parts by mass of polyurethane resin having a flow start temperature of 55° C. or more and 110° C. or less, (b) 5 to 150 parts by mass of saturated polyester resin having a Tg of 0° C. or more and 110° C. or less and a molecular weight of 10000 to 25000, (c) 10 to 150 parts by mass of epoxy resin having a softening point of 60° C. or more and 140° C. or less and a molecular weight of 700 to 3000, and (d) 10 to 200 parts by mass of an inorganic filler surface-treated with a coupling agent mixed therein (e.g., see PTL 1).

The adhesive has a practically usable level of moisture- and heat-resistance. However, the adhesive has a problem of insufficient water resistance properties; that is, when a multilayer body bonded using the adhesive is immersed in water, water may enter the multilayer body in a relatively short period of time.

Amid a strong desire in recent years for a material that enables a shorter curing time to improve production efficiency, the above-described moisture- and heat-resistant hot-melt adhesive composition, despite the advantage of being able to provide adhesion even at a time of low temperature, has not been practically usable in situations where faster curing is desired. Although a technique of improving fast curability by adding, for example, a catalyst, is conceivable, concern has been raised over, for example, a time-dependent viscosity increase, and thus it has been difficult to achieve a balance between such properties.

### CITATION LIST

### Patent Literature

PTL 1: Japanese Unexamined Patent Application
Publication No. 2003-27030

### SUMMARY OF INVENTION

### Technical Problem

An object of the present invention is to provide a moisture-curable polyurethane hot-melt resin composition that excels in storage stability, initial adhesive strength, water resistance, and drop impact resistance.

### Solution to Problem

The present invention provides a moisture-curable polyurethane hot-melt resin composition containing an isocyanate group-containing urethane prepolymer (i), where the moisture-curable polyurethane hot-melt resin composition further contains a curing catalyst (ii) represented by General Formula (1) below in an amount in a range of 0.2 to 1 parts by mass with respect to 100 parts by mass of the urethane prepolymer (i) and an organic acid (iii) having a sulfur atom in an amount in a range of 0.0001 to 0.5 parts by mass with respect to 100 parts by mass of the urethane prepolymer (i). The present invention also provides an article obtained by using the moisture-curable polyurethane hot-melt resin composition.

### Advantageous Effects of Invention

The moisture-curable polyurethane hot-melt resin composition according to the present invention has excellent storage stability that can mitigate a time-dependent viscosity increase. The moisture-curable polyurethane hot-melt resin composition according to the present invention can exhibit excellent initial adhesive strength and excellent final adhesive strength, and thus an article bonded using the polyurethane hot-melt resin composition excels in water resistance and drop impact resistance. Accordingly, the moisture-curable polyurethane hot-melt resin composition according to the present invention can be particularly suitably used for the bonding of optical members.

### DESCRIPTION OF EMBODIMENTS

A moisture-curable polyurethane hot-melt resin composition according to the present invention contains an isocyanate group-containing urethane prepolymer (i), a specific amount of a curing catalyst (ii), and a specific amount of an organic acid (iii).

As the isocyanate group-containing urethane prepolymer (i), for example, a reaction product of a polyol (A) and a polyisocyanate (B) can be used.

As the polyol (A), for example, a polyether polyol (A-1), a crystalline polyester polyol (A-2), an amorphous polyester polyol (A-3), an acrylic polyol (A-4), a polycarbonate polyol, a polybutadiene polyol, or a dimer diol can be used. These polyols may be used alone or in a combination of two or more.

As the polyol (A), among the above, a polyether polyol (A-1), a crystalline polyester polyol (A-2), an amorphous polyester polyol (A-3), and an acrylic polyol (A-4) are preferably used in view of the ability to obtain further excellent water resistance, further excellent adhesive strength, and further excellent drop impact resistance.

As the polyether polyol (A-1), for example, polyethylene glycol, polypropylene glycol, polybutylene glycol, polytetramethylene glycol, or polyoxyethylene polyoxypropylene glycol can be used.

The number average molecular weight of the polyether polyol (A-1) is preferably in a range of 500 to 10,000, more preferably in a range of 700 to 5,000 in view of the ability to obtain further excellent initial adhesive strength and moderate open time (usable time). The number average molecular weight of the polyether polyol (A-1) indicates a value measured through a gel permeation chromatography (GPC) method.

As the crystalline polyester polyol (A-2), for example, a reaction product of a hydroxy group-containing compound and a polybasic acid can be used. In the present invention, the term “crystalline” refers to a material exhibiting a peak due to the heat of crystallization or the heat of fusion confirmable in DSC (differential scanning calorimetry) measurement in accordance with JISK7121: 2012, while the term “amorphous” refers to a material exhibiting no such confirmable peak.

As the hydroxy group-containing compound, for example, ethylene glycol, propylene glycol, butanediol, pentanediol, hexanediol, heptanediol, octanediol, nonanediol, decanediol, trimethylolpropane, trimethylolethane, or glycerol can be used. These compounds can be used alone or in a combination of two or more. Among these, one or more selected from the group consisting of butanediol, hexanediol, octanediol, and decanediol is preferably used in view of the ability to enhance crystallinity and thereby obtain further excellent water resistance and further excellent adhesive strength.

As the polybasic acid, for example, oxalic acid, malonic acid, succinic acid, adipic acid, sebacic acid, azelaic acid, or 1,12-dodecanedicarboxylic acid can be used. These compounds can be used alone or in a combination of two or more.

The number average molecular weight of the crystalline polyester polyol (A-2) is preferably in a range of 500 to 10,000, more preferably in a range of 1,000 to 4,000 in view of the ability to obtain further excellent water resistance and further excellent adhesivity. The number average molecular weight of the crystalline polyester polyol (A-2) indicates a value measured through a gel permeation chromatography (GPC) method.

The glass transition temperature (Tg) of the crystalline polyester polyol (A-2) is preferably in a range of 40° C. to 130° C. The glass transition temperature of the crystalline polyester polyol (A-2) is in accordance with JIS K 7121-1987 and indicates a value measured through DSC. Specifically, the glass transition temperature indicates a midpoint glass transition temperature (Tmg) read from a differential thermal curve obtained when the crystalline polyester polyol (A-2) is placed in a differential scanning calorimetry apparatus, heated to (Tg+50° C.) at a heating rate of 10° C./min, maintained for 3 minutes, and quenched.

The usage amount of the crystalline polyester polyol (A-2) when used is preferably in a range of 20 to 150 parts by mass, more preferably in a range of 30 to 100 parts by mass with respect to 100 parts by mass of the ether polyol (A-1) in view of the ability to obtain further excellent flexibility, further excellent adhesivity, and further excellent open time.

As the amorphous polyester polyol (A-3), for example, a reaction product of a hydroxy group-containing compound and a polybasic acid as exemplified below can be used.

As the hydroxy group-containing compound, for example, ethylene glycol, propylene glycol, 1,4-butanediol, pentanediol, 2,4-diethyl-1,5-pentanediol, 3-methyl-1,5-pentanediol, hexanediol, neopentyl glycol, hexamethylene glycol, glycerol, or trimethylolpropane; or bisphenol A, bisphenol F, or an alkylene oxide adduct of the foregoing can be used. These compounds may be used alone or in a combination of two or more. Among these, an alkylene oxide adduct of bisphenol A is preferably used in view of the ability to obtain further excellent water resistance, further excellent adhesive strength, and further excellent flexibility. The number of added moles of the alkylene oxide is preferably 2 to 10 moles, more preferably 4 to 8 moles.

As the polybasic acid, for example, adipic acid, glutaric acid, pimelic acid, suberic acid, dimer acid, sebacic acid, undecanedicarboxylic acid, hexahydroterephthalic acid, phthalic acid, phthalic anhydride, isophthalic acid, or terephthalic acid can be used. These compounds can be used alone or in a combination of two or more.

The number average molecular weight of the amorphous polyester polyol (A-3) is preferably in a range of 500 to 10,000, more preferably in a range of 1,000 to 4,000, and even more preferably in a range of 1,000 to 3,000 in view of the ability to obtain further excellent water resistance, further excellent adhesivity, and further excellent flexibility. The number average molecular weight of the amorphous polyester polyol (A-3) indicates a value measured through a gel permeation chromatography (GPC) method.

The glass transition temperature of the amorphous polyester polyol (A-3) is preferably in a range of −70° C. to −10° C. in view of the ability to obtain further excellent water resistance, further excellent adhesivity, and further excellent flexibility. The glass transition temperature of the amorphous polyester polyol (A-3) is the same as the method for measuring the glass transition temperature (Tg) of the crystalline polyester polyol (A-2).

The usage amount of the amorphous polyester polyol (A-3) when used is preferably in a range of 20 to 150 parts by mass, more preferably in a range of 25 to 130 parts by mass, and even more preferably in a range of 55 to 100 parts by mass with respect to 100 parts by mass of the ether polyol (A-1) in view of the ability to obtain further excellent flexibility, further excellent adhesivity, further excellent flexibility, and further excellent adhesive strength.

As the acrylic polyol (A-4), for example, a polymer of a (meth)acrylic compound essentially containing a hydroxy group-containing (meth)acrylic compound can be used. In the present invention, the term “(meth)acrylic compound” refers to either or both of a methacrylic compound and an acrylic compound and the term “(meth)acrylate” refers to either or both of methacrylate and acrylate.

As the hydroxy group-containing (meth)acrylic compound, for example, 2-hydroxyethyl (meth)acrylate, hydroxypropyl (meth)acrylate, or hydroxybutyl (meth)acrylate can be used. These compounds may be used alone or in a combination of two or more.

As a (meth)acrylic compound other than the above, for example, a (meth)acrylic acid alkyl ester (meth)acrylic acid alkyl ester such as (meth)acrylic acid, methyl (meth)acrylate, ethyl (meth)acrylate, n-butyl (meth) acrylate, isobutyl (meth) acrylate, tert-butyl (meth) acrylate, neopentyl (meth) acrylate, 2-ethylhexyl (meth)acrylate, octyl (meth)acrylate, stearyl (meth)acrylate, isostearyl (meth)acrylate, cetyl (meth)acrylate, or lauryl (meth)acrylate; a (meth)acrylic compound having a fluorine atom, such as 2,2,2-trifluoroethyl (meth)acrylate, 2,2,3,3-tetrafluoropropyl (meth)acrylate, 1H,1H,5H-octafluoropentyl (meth)acrylate, or 2-(perfluorooctyl)ethyl (meth)acrylate; a (meth)acrylic compound having an alicyclic structure, such as isobornyl (meth) acrylate, cyclohexyl (meth) acrylate, dicyclopentanyl (meth) acrylate, or dicyclopentenyloxyethyl (meth) acrylate; an ether group-containing (meth)acrylic compound such as polyethylene glycol mono(meth)acrylate, methoxyethyl (meth) acrylate, methoxybutyl (meth) acrylate, methoxytriethylene glycol (meth)acrylate, or methoxypolyethylene glycol (meth)acrylate; or benzyl (meth) acrylate, 2-ethyl-2-methyl-[1,3]-dioxolane-4-yl-methyl (meth)acrylate, or dimethylaminoethyl (meth)acrylate can be used. These compounds can be used alone or in a combination of two or more. Among these, a hydroxy group-containing (meth)acrylic compound and a (meth)acrylic acid alkyl ester are preferably used, and 2-hydroxyethyl (meth)acrylate, methyl (meth)acrylate, and n-butyl (meth)acrylate are more preferably used in view of the ability to obtain further excellent water resistance, further excellent adhesivity, and further excellent open time.

The number average molecular weight of the acrylic polyol (A-4) is preferably in a range of 5,000 to 100,000, more preferably in a range of 10,000 to 30,000 in view of the ability to obtain further excellent water resistance, further excellent adhesivity, and further excellent open time. The number average molecular weight of the acrylic polyol (A-4) indicates a value measured through a gel permeation chromatography (GPC) method.

The glass transition temperature of the acrylic polyol (A-4) is preferably in a range of 30° C. to 120° C., more preferably in a range of 50° C. to 80° C. in view of the ability to obtain further excellent water resistance, further excellent adhesive strength, and further excellent open time. The glass transition temperature of the acrylic polyol (A-4) is the same as the method for measuring the glass transition temperature (Tg) of the crystalline polyester polyol (A-2).

The usage amount of the acrylic polyol (A-4) when used is preferably in a range of 20 to 400 parts by mass, more preferably in a range of 25 to 200 parts by mass, and even more preferably in a range of 35 to 150 parts by mass with respect to 100 parts by mass of the ether polyol (A-1) in view of the ability to obtain further excellent water resistance, further excellent open time, and further excellent adhesive strength.

As the polyisocyanate (B), for example, an aromatic polyisocyanate such as polymethylene polyphenyl polyisocyanate, diphenylmethane diisocyanate, carbodiimide-modified diphenylmethanediisocyante isocyanate, phenylene diisocyanate, tolylene diisocyanate, or naphthalene diisocyanate; or an aliphatic or alicyclic polyisocyanate such as hexamethylene diisocyanate, lysine diisocyanate, cyclohexane diisocyanate, isophorone diisocyanate, dicyclohexylmethane diisocyanate, xylylene diisocyanate, or tetramethyl xylylene diisocyanate can be used. Among these, an aromatic polyisocyanate is preferably used, and diphenylmethane diisocyanate is more preferable in view of the ability to obtain further excellent reactivity and further excellent adhesivity.

The usage amount of the polyisocyanate (B) is preferably in a range of 5% to 60% by mass, more preferably in a range of 10% to 30% by mass in the material of the urethane prepolymer (i) in view of the ability to obtain further excellent adhesive strength.

The urethane prepolymer (i) is a reaction product of the polyol (A) and the polyisocyanate (B) and has, at polymer ends and in the molecule thereof, isocyanate groups that can react with a water content present in air or in a housing or an adherend to which the urethane prepolymer is applied to form a crosslinked structure.

In a method for manufacturing the urethane prepolymer (i), for example, the polyol (A) is added dropwise to a reaction container containing the polyisocyanate (B). Subsequently, the mixture is heated and reacted under conditions in which isocyanate groups in the polyisocyanate (B) are present in a larger amount than hydroxy groups in the polyol (A) to thereby enable the manufacture.

When the urethane prepolymer (i) is manufactured, the equivalence ratio of isocyanate groups in the polyisocyanate (B) to hydroxy groups in the polyol (A) [isocyanate groups/hydroxy groups] is preferably in a range of 1.1 to 5, more preferably in a range of 1.5 to 3 in view of the ability to obtain further excellent water resistance, further excellent adhesivity, and further excellent flexibility.

The isocyanate group content in the urethane prepolymer (i) (hereafter abbreviated as “NCO%”) is preferably in a range of 1.5% to 8%, more preferably in a range of 1.7% to 5%, and even more preferably in a range of 1.8% to 3% in view of the ability to obtain further excellent water resistance, further excellent adhesivity, and further excellent flexibility. The NCO % of the urethane prepolymer (i) is in accordance with JISK1603-1: 2007 and indicates a value measured through a potentiometric titration method.

When it comes to the viscosity of the urethane prepolymer (i), the melt viscosity at 125° C. is preferably in a range of 1,000 to 50,000 mPa·s, more preferably in a range of 2,000 to 10,000 mPa·s in view of the ability to obtain further excellent water resistance and further excellent adhesive strength. The melt viscosity at 125° C. indicates a value measured with a cone-and-plate viscometer (manufactured by ICI).

The softening point of the urethane prepolymer (i) is preferably in a range of 30° C. to 120° C. in view of the ability to obtain further excellent water resistance and further excellent adhesive strength. The term “softening point” refers to the temperature at which the urethane prepolymer starts to thermally flow and loses cohesive force when the temperature of the urethane prepolymer is increased in stages. The softening point of the urethane prepolymer (i) indicates a value calculated through a ring-and-ball method in accordance with JIS K 5902.

As the curing catalyst (ii), a curing catalyst represented by General Formula (1) below is essentially used to obtain excellent water resistance, excellent drop impact resistance, and excellent initial adhesive strength.

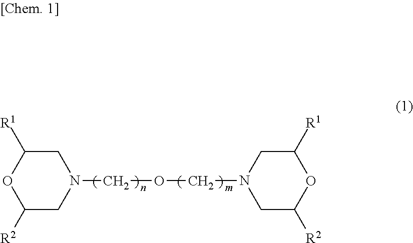

(wherein R¹ and R² each independently represent a hydrogen atom or an alkyl group, and n and m each independently represent an integer of 1 to 6.)

As the curing catalyst (ii), dimorpholinodiethyl ether represented by General Formula (2) below and/or bis(2,6-dimethylmorpholinoethyl) ether represented by General Formula (3) below are preferably used in view of the ability to obtain further excellent initial adhesive strength.

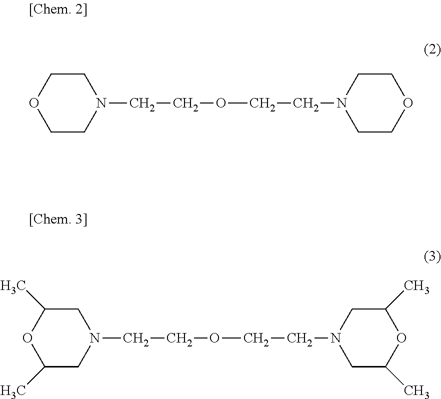

The usage amount of the curing catalyst (ii) is essentially in a range of 0.2 to 1 parts by mass with respect to 100 parts by mass of the urethane prepolymer (i) to obtain excellent initial adhesive strength. When the usage amount of the curing catalyst (ii) is less than 0.2 parts by mass with respect to 100 parts by mass of the urethane prepolymer (i), particularly desired initial adhesive strength is not obtainable, and when the usage amount is more than 1 part by mass, gelation or an increase in the time-dependent viscosity increase rate occurs, resulting in extremely poor storage stability. The usage amount of the curing catalyst (ii) is preferably in a range of 0.25 to 0.85 parts by mass, more preferably in a range of 0.3 to 0.7 parts by mass with respect to 100 parts by mass of the urethane prepolymer (i) in view of the ability to obtain further excellent storage stability, further excellent final adhesive strength, and further excellent drop impact resistance.

The organic acid (iii) having a sulfur atom is an essential component to obtain excellent storage stability. As the organic acid (iii), for example, a sulfonic acid compound or a sulfinic acid compound can be used. These compounds may be used alone or in a combination of two or more.

As the sulfonic acid compound, for example, methanesulfonic acid, ethanesulfonic acid, methanedisulfonic acid, methanedisulfonic acid, 2-hydroxy-l-ethanesulfonic acid, sulfoacetic acid, 2-amino-l-ethanesulfonic acid, trifluoromethanesulfonic acid, benzenesulfonic acid, or toluenesulfonic acid can be used. These compounds may be used alone or in a combination of two or more.

As the sulfinic acid compound, for example, methanesulfinic acid or ethanesulfinic acid can be used. These compounds may be used alone or in a combination of two or more.

As the organic acid (iii), among the above, a sulfonic acid compound is preferably used, methanesulfonic acid and/or ethanesulfonic acid is more preferably used, and methanesulfonic acid is even more preferably used in view of the ability to obtain further excellent storage stability.

The usage amount of the organic acid (iii) is essentially in a range of 0.0001 to 0.5 parts by mass with respect to 100 parts by mass of the urethane prepolymer (i) to obtain excellent storage stability. When the usage amount of the organic acid (iii) is less than 0.0001 parts by mass with respect to 100 parts by mass of the urethane prepolymer (i), desirable storage stability is not obtainable. When the usage amount is more than 0.5 parts by mass, the problem of negatively affecting adhesive strength, drop impact resistance, and water resistance is present. The usage amount of the organic acid (iii) is preferably in a range of 0.0005 to 0.1 parts by mass, more preferably in a range of 0.001 to 0.08 parts by mass with respect to 100 parts by mass of the urethane prepolymer (i) in view of the ability to obtain further excellent storage stability.

The mass ratio of the curing catalyst (ii) to the organic acid (iii) [(ii)/(iii)] is preferably in a range of 70/30 to 99.5/0.5, more preferably in a range of 92/8 to 99/1 in view of the ability to further enhance a balance between storage stability, initial adhesive strength, water resistance, and drop impact resistance.

The moisture-curable polyurethane hot-melt resin composition according to the present invention contains, as essential components, the urethane prepolymer (i), the curing catalyst (ii), and the organic acid (iii), but may contain other additives as needed.

As such other additives, for example, antioxidants, tackifiers, plasticizers, stabilizers, filling materials, dyes, pigments, fluorescent brighteners, silane coupling agents, and waxes can be used. These additives may be used alone or in a combination or two or more.

Thus, the moisture-curable polyurethane hot-melt resin composition according to the present invention has excellent storage stability that can mitigate a time-dependent viscosity increase. The moisture-curable polyurethane hot-melt resin composition according to the present invention can exhibit excellent initial adhesive strength and excellent final adhesive strength, and thus an article bonded using the polyurethane hot-melt resin composition excels in water resistance and drop impact resistance. Accordingly, the moisture-curable polyurethane hot-melt resin composition according to the present invention can be particularly suitably used not only for the bonding of fibers and the lamination of building materials but also for the bonding of optical members.

Examples of aspects used for the bonding of such optical members include sealants for cellular phones, personal computers, gaming devices, television sets, automotive navigation systems, and camera speakers.

A method used when such bonding is performed is, for example, a method in which the moisture-curable polyurethane hot-melt resin composition is heat-melted in a temperature range of 50° C. to 130° C. and applied to one of the members, and subsequently, the other member is bonded to the composition to obtain an article.

As the members, members obtainable from, for example, glass, acrylic resin, urethane resin, silicone resin, epoxy resin, fluorine resin, polystyrene resin, polyester resin, polysulfone resin, polyarylate resin, polyvinyl chloride resin, polyvinylidene chloride, cycloolefin resin such as norbornene, polyolefin resin, polyimide resin, alicyclic polyimide resin, cellulose resin, PC (polycarbonate), PBT (polybutylene terephthalate), modified PPE (polyphenylene ether), PEN (polyethylene naphthalate), PET (polyethylene terephthalate), a lactic acid polymer, ABS resin, or AS resin can be used. The members may be subjected to, for example, corona treatment, plasma treatment, or primer treatment.

The method for applying the moisture-curable polyurethane hot-melt resin composition, is, for example, a method using a roll coater, a spray coater, a T-tie coater, a knife coater, or a comma coater.

The moisture-curable polyurethane hot-melt resin composition according to the present invention, because of having low viscosity and excellent shape retention capabilities after application is performed, can be applied with a technique such as of a dispenser, ink jet printing, screen printing, or offset printing. With such an application technique, the moisture-curable polyurethane hot-melt resin composition can be applied to a desired location of the members and thus no loss such as by punching occurs; therefore, such a technique is preferable. With such an application technique, the moisture-curable polyurethane hot-melt resin composition can be applied to the members, continuously or intermittently, in various shapes such as dots, lines, triangles, quadrangles, circles, and curves.

The thickness of a cured product layer (adhesive layer) of the moisture-curable polyurethane hot-melt resin composition can be appropriately set according to the usage for use but, for example, is in a range of 10 μm to 5 mm. [0063]

The aging conditions after the above-described bonding is performed can be appropriately determined, for example, in a range of temperatures of 20° C. to 80° C., in a range of relative humidities of 50% RH to 90% RH, and in a range of 0.5 to 3 days.

### EXAMPLES

Hereafter, the present invention will be described in further detail with reference to Examples.

### Synthesis Example 1

### <Synthesis of Acrylic Polyol-1>

Into a reaction container including a thermometer, a stirrer, and a cooling pipe, 300 parts by mass of methyl ethyl ketone was placed, and after the container temperature was set to 80° C., 160 parts by mass of methyl ethyl ketone with 340 parts by mass of methacrylic acid, 340 parts by mass of butyl methacrylate, 10 parts by mass of 2-hydroxyethyl methacrylate, and 8.5 parts by mass of azobisisobutyronitrile dissolved therein was added and mixed, and the mixture was reacted for 16 hours to obtain an acrylic polyol-1 (nonvolatile component: 52% by mass, viscosity: 20,000 mPa·s (23° C.)).

### Synthesis Example 2

<Synthesis of Urethane Prepolymer (i-1)>

Into a four-neck flask including a thermometer, a stirrer, an inert gas inlet, and a reflux cooler, 15 parts by mass of polypropylene glycol (number average molecular weight: 1,000), 15 parts by mass of polypropylene glycol (number average molecular weight: 2,000, hereafter abbreviated as “PPG2000”), 20 parts by mass of a crystalline polyester polyol (a reaction product of 1,6-hexanediol and 1,12-dodecanedicarboxylic acid, number average molecular weight: 3,500), 7.5 parts by mass of an amorphous polyester polyol (a reaction product of a 6-mole adduct of propylene oxide of bisphenol A, sebacic acid, and isophthalic acid, number average molecular weight: 2,000), 7.5 parts by mass of an amorphous polyester polyol (a reaction product of neopentyl glycol, diethylene glycol, 1,6-hexanediol, and adipic acid, number average molecular weight: 2,000), and 20 parts by mass of a solvent of the acrylic polyol-1 dried and hardened were charged. The polyol mixture was dehydrated to a water content of 0.05% by mass or less at 100° C. under reduced pressure.

Subsequently, after the container temperature was cooled to 70° C., 15.5 parts by mass of 4,4′-diphenylmethane diisocyanate (MDI) was added thereto. The mixture was heated to 100° C. and then reacted for about 3 hours until the NCO group content became constant to obtain an isocyanate group-containing urethane prepolymer (i-1).

### [Method for Measuring Number Average Molecular Weight]

In the above-described Synthesis Example, the number average molecular weight of the polyols indicates a value measured through a gel permeation chromatography (GPC) method under the conditions below.

Measurement Apparatus: High-speed GPC apparatus (“HLC-8220GPC”, manufactured by Tosoh Corporation)

Column: The columns below manufactured by Tosoh

Corporation were used by connecting them in series.

“TSKgel G5000” (7.8 mm I.D.×30 cm)×1

“TSKgel G4000” (7.8 mm I.D.×30 cm)×1

“TSKgel G3000” (7.8 mm I.D.×30 cm)×1

“TSKgel G2000” (7.8 mm I.D.×30 cm)×1

Detector: RI (differential refractometer)

Column temperature: 40° C.

Eluent: Tetrahydrofuran (THF)

Flow rate: 1.0 mL/min

Injection amount: 100 μL (tetrahydrofuran solution having a sample concentration of 0.4% by mass)

Standard sample: The standard polystyrenes below were used to form a calibration curve.

### (Standard Polystyrene)

“TSKgel Standard Polystyrene A-500” manufactured by Tosoh Corporation

“TSKgel Standard Polystyrene A-1000” manufactured by Tosoh Corporation

“TSKgel Standard Polystyrene A-2500” manufactured by Tosoh Corporation

“TSKgel Standard Polystyrene A-5000” manufactured by Tosoh Corporation

“TSKgel Standard Polystyrene F-1” manufactured by Tosoh Corporation

“TSKgel Standard Polystyrene F-2” manufactured by Tosoh Corporation

“TSKgel Standard Polystyrene F-4” manufactured by Tosoh Corporation

“TSKgel Standard Polystyrene F-10” manufactured by Tosoh Corporation

“TSKgel Standard Polystyrene F-20” manufactured by Tosoh Corporation

“TSKgel Standard Polystyrene F-40” manufactured by Tosoh Corporation

“TSKgel Standard Polystyrene F-80” manufactured by

Tosoh Corporation

“TSKgel Standard Polystyrene F-128” manufactured by Tosoh Corporation

“TSKgel Standard Polystyrene F-288” manufactured by Tosoh Corporation

“TSKgel Standard Polystyrene F-550” manufactured by Tosoh Corporation

### Example 1

A total of 100 parts by mass of the urethane prepolymer (i-1) obtained in Synthesis Example 2, 0.4 parts by mass of bis(2,6-dimethylmorpholinoethyl) ether, and 0.03 parts by mass of methanesulfonic acid were mixed to obtain a moisture-curable polyurethane hot-melt resin composition.

### Examples 2 to 6, Comparative Examples 1 to 4

Except that the types and/or amounts of the curing catalyst (ii) and the organic acid (iii) used were changed as presented in Tables 1 to 2, the same procedure as in Example 1 was performed to obtain a moisture-curable polyurethane hot-melt resin composition.

### [Method for Evaluating Storage Stability]

### (Method for Evaluating Initial Viscosity)

Immediately after the moisture-curable polyurethane hot-melt resin composition was obtained in each Example and each Comparative Example, the moisture-curable polyurethane hot-melt resin composition was melted to 110° C., 1 ml thereof was sampled, and the viscosity of the sample was measured with a cone-and-plate viscometer (40 P cone, rotor rotational speed: 50 rpm).

### (Method for Measuring Time-Dependent Viscosity)

The moisture-curable polyurethane hot-melt resin composition obtained in each Example and each Comparative Example was left to stand under a condition of 50° C. for 4 weeks, after which the same procedure as above was performed to measure the viscosity of the resin composition.

### (Evaluation)

The evaluation was determined to be “O” when the number obtained by dividing the value of the time-dependent viscosity by the value of the initial viscosity was less than 1.3, while the evaluation was determined to be “X” when the number was 1.3 or more.

### [Method for Producing Article]

The moisture-curable polyurethane hot-melt resin composition obtained in each Example and each Comparative Example was melted to 110° C. With a dispenser needle having an inner diameter of 0.4 mm (“ML-5000Xii”, manufactured by Musashi Engineering, Inc.) that had been pre-heated to 110° C., the moisture-curable polyurethane hot-melt resin composition was then applied, in the shape of an 1-inch circle having a thickness of 0.2 mm, to a PC plate (5 cm×9 cm) having a hole having a diameter of 1 cm at the center thereof under conditions of discharge pressure: 0.3 MPa, speed: 50 mm/s, an acrylic plate (5 cm×5 cm) was bonded thereto, and the resulting body was left to stand in a thermo-hygrostat chamber at a temperature of 23° C. and a humidity of 50% to produce an article.

### [Method for Measuring Initial Adhesive Strength]

In the above-described [Method for Producing Article], each article was removed after being left to stand in the thermo-hygrostat chamber for 30 minutes, and the push strength of the article was measured with an autograph (AUTOGRAPH “AGS-X”, manufactured by Shimadzu Corporation) under a condition of crosshead speed: 10 mm/min to thereby measure initial adhesive strength (N/cm²). When the initial adhesive strength was 70 N/cm² or more, the article was determined to have excellent initial adhesive strength.

### [Method for Measuring Final Adhesive Strength]

In the above-described [Method for Producing Article], each article was removed after being left to stand in the thermo-hygrostat chamber for 48 hours, and the same procedure as above was performed to measure the final adhesive strength (N/cm²) with a Tensilon tester.

### [Method for Measuring Drop Impact Resistance]

After the adhesive strength measurement was performed on each article in the above-described [Method For Measuring Final Adhesive Strength], with a DuPont drop impact tester, an impact from an acrylic plate was applied three times to each article with an impact punch interposed therebetween under conditions of load: 100 g, height: 10 cm. When no peeling occurred on the PC plate, the drop impact resistance test on each article was continued under a condition of the height being increased by 10 cm. The presence or absence of peeling was confirmed for each article through visual observation and the height (cm) at which peeling occurred was evaluated. When the height was 30 cm or more, the article was determined to excel in drop impact resistance.

### [Method for Measuring Water Resistance]

The moisture-curable polyurethane hot-melt resin composition obtained in each Example and each Comparative Example was melted to 110° C. With a dispenser needle having an inner diameter of 0.4 mm (“ML-5000Xii”, manufactured by Musashi Engineering, Inc.) that had been pre-heated to 110° C., the moisture-curable polyurethane hot-melt resin composition was then applied, in the shape of an 1-inch circle having a thickness of 0.2 mm, to a PC plate (5 cm×9 cm) having no hole at the center thereof under conditions of discharge pressure: 0.3 MPa, speed: 50 mm/s, an acrylic plate (5 cm×5 cm) was bonded thereto, and the resulting body was left to stand in a thermo-hygrostat chamber at a temperature of 23° C. and a humidity of 50% for 48 hours to produce an article for evaluation.

After being subjected to water immersion (23° C., 0.5 hours), each article for evaluation was subjected to evaluation of the presence or absence of water entry into the article in accordance with JIS IPX-7. The article for which no water entry was confirmed was evaluated as “0” due to the excellence in water resistance, while the article for which water entry was confirmed was evaluated as “x”.

TABLE 1

| | | Example | Example | Example | Example | Example |
|---|---|---|---|---|---|---|
| | | 1 | 2 | 3 | 4 | 5 |
| Urethane prepolymer (i) | | (i-1) | (i-1) | (i-1) | (i-1) | (i-1) |
| Curing catalyst (ii) | Bis(2,6- | 0.4 | 0.8 | 0.4 | 0.5 | 0.4 |
| (Parts by mass) | dimethylmorpholinoethyl)ether | | | | | |
| | Dimorpholinodiethyl ether | | | | | |
| Organic acid (iii) | Methanesulfonic acid | 0.03 | 0.03 | 0.005 | 0.03 | |
| (Parts by mass) | Ethanesulfonic acid | | | | | 0.03 |
| Storage stability | Initial viscosity (mPa · s) | 7620 | 8070 | 7770 | 7810 | 7600 |
| | Time-dependent viscosity (mPa · s) | 8100 | 9300 | 8400 | 8350 | 8150 |
| | Evaluation | ∘ | ∘ | ∘ | ∘ | ∘ |
| Adhesive strength | Initial adhesive strength (N/cm²) | 108 | 120 | 100 | 112 | 105 |
| | Final adhesive strength (N/cm²) | 280 | 187 | 210 | 285 | 265 |
| Drop impact | Height (cm) | 40 | 30 | 50 | 40 | 40 |
| resistance | | | | | | |
| Water resistance | Evaluation | ∘ | ∘ | ∘ | ∘ | ∘ |

TABLE 2

| | | Example | Comparative | Comparative | Comparative | Comparative |
|---|---|---|---|---|---|---|
| | | 6 | Example 1 | Example 2 | Example 3 | Example 4 |
| Urethane prepolymer (i) | | (i-1) | (i-1) | (i-1) | (i-1) | (i-1) |
| Curing catalyst (ii) | Bis(2,6- | | 0.1 | 1.5 | 0.4 | 0.4 |
| (Parts by mass) | dimethylmorpholinoethyl)ether | | | | | |
| | Dimorpholinodiethyl ether | 0.4 | | | | |
| Organic acid (iii) | Methanesulfonic acid | 0.03 | 0.003 | 0.03 | 0.00001 | 0.8 |
| (Parts by mass) | Ethanesulfonic acid | | | | | |
| Storage stability | Initial viscosity (mPa · s) | 7700 | 5500 | Gelled | 7800 | 10260 |
| | Time-dependent viscosity (mPa · s) | 8300 | 6000 | | 11500 | 10530 |
| | Evaluation | ∘ | ∘ | | x | ∘ |
| Adhesive strength | Initial adhesive strength (N/cm²) | 111 | 30 | | 103 | 32 |
| | Final adhesive strength (N/cm²) | 250 | 150 | | 170 | 155 |
| Drop impact | Height (cm) | 40 | 40 | | 20 | 20 |
| resistance | | | | | | |
| Water resistance | Evaluation | ∘ | x | | x | x |

The moisture-curable polyurethane hot-melt resin compositions in Examples 1 to 6, which were the moisture-curable polyurethane hot-melt resin compositions according to the present invention, were found to excel in storage stability, initial adhesive strength, water resistance, and drop impact resistance.

On the other hand, Comparative Example 1, which is an aspect with the usage amount of the curing catalyst (ii) being less than the range specified in the present invention, was poor in initial adhesive strength and water resistance.

Comparative Example 2, which is an aspect with the usage amount of the curing catalyst (ii) exceeding the range specified in the present invention, gelled.

Comparative Example 3, which is an aspect with the usage amount of the organic acid (iii) being less than the range specified in the present invention, was poor in storage stability, drop impact resistance, and water resistance.

Comparative Example 4, which is an aspect with the usage amount of the organic acid (iii) exceeding the range specified in the present invention, was poor in initial viscosity, initial adhesive strength, drop impact resistance, and water resistance.

1. A moisture-curable polyurethane hot-melt resin composition comprising an isocyanate group-containing urethane prepolymer (i), wherein
the moisture-curable polyurethane hot-melt resin composition further contains a curing catalyst (ii) represented by General Formula (1) below in an amount in a range of 0.2 to 1 parts by mass with respect to 100 parts by mass of the urethane prepolymer (i) and an organic acid (iii) having a sulfur atom in an amount in a range of 0.0001 to 0.5 parts by mass with respect to 100 parts by mass of the urethane prepolymer (i). 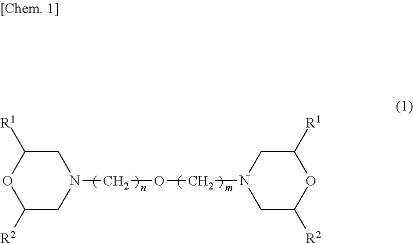
(wherein R¹ and R² each independently represent a hydrogen atom or an alkyl group, and n and m each independently represent an integer of 1 to 6.)

2. The moisture-curable polyurethane hot-melt resin composition according to claim 1, wherein a mass ratio of the curing catalyst (ii) to the organic acid (iii) [(ii)/(iii)] is in a range of 70/30 to 99.5/0.5.

3. The moisture-curable polyurethane hot-melt resin composition according to claim 1, wherein the curing catalyst (ii) is dimorpholinodiethyl ether and/or bis(2,6-dimethylmorpholinoethyl) ether.

4. The moisture-curable polyurethane hot-melt resin composition according to claim 1, wherein the organic acid (iii) is a sulfonic acid compound.

5. The moisture-curable polyurethane hot-melt resin composition according to claim 4, wherein the sulfonic acid compound is methanesulfonic acid and/or ethanesulfonic acid.

6. The moisture-curable polyurethane hot-melt resin composition according to claim 1, wherein the urethane prepolymer (i) is a reaction product of a polyol (A) containing a polyether polyol (a-1), a crystalline polyester polyol (a-2), an amorphous polyester polyol (a-3), and an acrylic polyol (a-4) and a polyisocyanate (B).

7. An article comprising at least two members bonded using the moisture-curable polyurethane hot-melt resin composition according to claim.

8. The moisture-curable polyurethane hot-melt resin composition according to claim 2, wherein the curing catalyst (ii) is dimorpholinodiethyl ether and/or bis(2,6-dimethylmorpholinoethyl) ether.

9. The moisture-curable polyurethane hot-melt resin composition according to claim 2, wherein the organic acid (iii) is a sulfonic acid compound.

10. The moisture-curable polyurethane hot-melt resin composition according to claim 3, wherein the organic acid (iii) is a sulfonic acid compound.

11. The moisture-curable polyurethane hot-melt resin composition according to claim 9, wherein the sulfonic acid compound is methanesulfonic acid and/or ethanesulfonic acid.

12. The moisture-curable polyurethane hot-melt resin composition according to claim 2, wherein the urethane prepolymer (i) is a reaction product of a polyol (A) containing a polyether polyol (a-1), a crystalline polyester polyol (a-2), an amorphous polyester polyol (a-3), and an acrylic polyol (a-4) and a polyisocyanate (B).

13. The moisture-curable polyurethane hot-melt resin composition according to claim 3, wherein the urethane prepolymer (i) is a reaction product of a polyol (A) containing a polyether polyol (a-1), a crystalline polyester polyol (a-2), an amorphous polyester polyol (a-3), and an acrylic polyol (a-4) and a polyisocyanate (B).

14. The moisture-curable polyurethane hot-melt resin composition according to claim 4, wherein the urethane prepolymer (i) is a reaction product of a polyol (A) containing a polyether polyol (a-1), a crystalline polyester polyol (a-2), an amorphous polyester polyol (a-3), and an acrylic polyol (a-4) and a polyisocyanate (B).

15. The moisture-curable polyurethane hot-melt resin composition according to claim 5, wherein the urethane prepolymer (i) is a reaction product of a polyol (A) containing a polyether polyol (a-1), a crystalline polyester polyol (a-2), an amorphous polyester polyol (a-3), and an acrylic polyol (a-4) and a polyisocyanate (B).

16. . An article comprising at least two members bonded using the moisture-curable polyurethane hot-melt resin composition according to claim 2.

17. An article comprising at least two members bonded using the moisture-curable polyurethane hot-melt resin composition according to claim 3.

18. An article comprising at least two members bonded using the moisture-curable polyurethane hot-melt resin composition according to claim 4.

19. An article comprising at least two members bonded using the moisture-curable polyurethane hot-melt resin composition according to claim 5.

20. An article comprising at least two members bonded using the moisture-curable polyurethane hot-melt resin composition according to claim 6.
